(19) United States
(12) Patent Application Publication
(10) Pub. No.: US 2009/0249203 A1
(43) Pub. Date: Oct. 1, 2009

(54) USER INTERFACE DEVICE, COMPUTER PROGRAM, AND ITS RECORDING MEDIUM

(76) Inventors: Akira Tsuruta, Nara (JP); Tomokazu Morio, Nara (JP)

Correspondence Address: BIRCH STEWART KOLASCH & BIRCH, PO BOX 747, FALLS CHURCH, VA, 22040-0747, US

(21) Appl. No.: 12/374,143

(22) PCT Filed: Jul. 9, 2007
(86) PCT No.: PCT/JP2007/063690

§ 371 Date: Jan. 16, 2009

(30) Foreign Application Priority Data
Jul. 20, 2006 (JP) 2009-198557

(51) Int. Cl. G06F 3/041; G06F 3/048

(52) U.S. Cl. 715/702; 715/841; 715/804

(57) ABSTRACT

An interface device executes a first display process, a moving and display process and a second display process. In the first display process, a plurality of items each including hiragana of Japanese alphabet, are displayed on a full screen liquid display touch panel. In the moving and display process, when one of the plurality of items is touched or touched and dragged, the hiragana of the item is displayed at a position different from the original display position. In the second display process, a touch-up on the full screen liquid crystal touch panel is detected, and a list of options whose names start from the hiragana in the item corresponding to the touched-up position or related information thereto, among the plurality of options, is displayed. Thus, it is possible to easily display a list of desired option group from the options, on the user interface device.

### TECHNICAL FIELD

The present invention relates to an information processing device and user interface in the information processing device and, more specifically, to an improvement in user interface for efficiently searching characters and items such as menu items, in an information processing device having a large number of functions for its housing size such as a portable telephone.

### BACKGROUND ART

As is well known, various types of terminal devices have been developed. Among the terminal devices, portable telephones and remote controllers have been known as portable terminals. Some of such terminal devices have a display screen and operation buttons and some have operation buttons only, in accordance with intended use, and there are many variations.

By way of example, a portable telephone as a terminal device needs not only operation buttons but also a display screen to confirm the input telephone number and mail message. In contrast, in connection with a remote controller used for operating a television receiver (TV), necessary information can be displayed on the TV screen. Therefore, it is unnecessary to provide a screen on a common TV remote controller.

Recently, striking technical developments have been made for various types of terminal devices as described above. With the advance in technology, terminal devices have come to incorporate various functions. As there are so many different functions, it becomes a major challenge in using a terminal device how efficiently a desired function can be searched for and found in a short period of time.

Here, the operation of “searching for a function” includes an operation of searching for a desired function among a plurality of possible options. For instance, a common method of searching for a function in a portable telephone at present utilizes a hierarchical structure, in which selection is repeated until a desired function is reached, using a combination of upper layer options and lower layer options. By repeating the selection, a desired function can be searched and found.

There are various techniques for realizing such a selecting operation. Patent Document 1 discloses one such technique. According to the technique disclosed in Patent Document 1, a display screen serves as a touch panel, and by touching the touch panel, a desired option is selected. When an option is touched, the touched option and options close thereto are displayed in enlargement. Further, the enlarged option is displayed brighter than before selection. Enlarged display of an option eases selection, and brighter display also eases selection. Therefore, such a process makes it easier to select the desired option.

Further, Patent Document 1 also applies another method in which the touched option is displayed in enlargement on a separate window newly opened on the screen, to facilitate selection of the desired option.

### Patent Document 1. Japanese Patent Laying-Open No. 2001-109557

### Non-Patent Document 1:

### DISCLOSURE OF THE INVENTION

### Problems to be Solved by the Invention

According to the technique of Patent Document 1 described above, when the selected option is displayed in enlargement, other options are hidden by the enlarged option. As other options are hidden, it becomes difficult to select an option other than the one displayed in enlargement. If a separate window is opened and the selected option is displayed on the separate window, again, the problem that other options are hidden by the separate window arises. These problems may possibly make it difficult to select a function.

Therefore, an object of the present invention is to provide a user interface device, a computer program and its recording medium that allow efficient selection of a desired one among a plurality of options, while supporting increasing number of functions of user interface of, for example, a portable telephone.

### Means for Solving the Problems

Specific inventions to solve the above-described problem are as follows.

According to a first aspect, the present invention provides a user interface device, including: first display means for displaying a plurality of items each including a sign, on a touch panel having a display function; moving and display means for displaying, when one of the plurality of items is touched or touched and dragged, the sign of the corresponding item at a position different from original display position; and a second display means for detecting a touch-up on the touch panel and displaying a list of options of a prescribed relation with the sign in, or related information of, an item corresponding to the touched-up position, among a plurality of options prepared in advance.

In the arrangement above, when the user touches any of the items displayed on the touch panel, a sign of the item is displayed at a position different from the original position. At the time of touching, normally, one touches the place where the sign is displayed, with one's finger. As the sign is displayed at a position different from the original display position, it is not possible that the sign is hidden by the finger and cannot be seen, and hence, the desired item can easily be selected. Further, by detecting a touch-up, a list of options having a prescribed relation with the sign in the item corresponding to the touched-up position, among the plurality of options, is displayed. Therefore, a user interface device that can display a list of options by a simple operation and allows easy finding of an intended option, can be provided.

Preferably the moving and display means includes means for successively changing, when touched and thereafter dragged, display of a sign of the corresponding item in accordance with the dragged position.

In the arrangement above, when touched and thereafter dragged, display of a sign of the item is changed in accordance with the drag position. Therefore, items change successively along with the simple movement of one's finger, that is, the simple operation of dragging. As a result, a user interface device can be provided in which, by a simple operation of touching a position near the intended option and dragging to the intended option, an arbitrary option can reliably be selected.

Preferably, the first display means includes means for displaying, on the touch panel, the plurality of items along a prescribed first direction, and displaying, in each item, the sign of the corresponding item at a position different from a sign of an adjacent item, in a second direction intersecting the first direction.

In the arrangement above, the signs are displayed such that the position in the second direction of a sign included in a prescribed item is different from the position in the second direction of a sign in an adjacent item. Each of the signs can be distinguished easily when the user touches a sign. Even if one's finger is too large for the size of the item, it is possible to easily distinguish the plurality of signs and touch. This reduces touching error. As a result, a user interface device can be provided in which arbitrary options can reliably be displayed in a list by a simple operation and an intended option can easily be found.

Preferably, the moving and display means includes means for enlarging, when one of a plurality of items arranged along a prescribed first direction on the panel is touched or touched and dragged, size of display of the item in the first direction, and moving and displaying a sign that has been displayed in the item to an end portion of the item.

In the arrangement above, when one of the plurality of items is touched, the display size of the item in the first direction is enlarged, and the sign displayed in the item is displayed moved to an end position of the corresponding item. As the item is displayed in enlargement, it become easier to visually recognize the touched item and the sign included in the item. As a result, a user interface device can be provided in which arbitrary options can reliably be displayed in a list by a simple operation and an intended option can easily be found.

Preferably, the moving and display means includes means for opening, when one of the plurality of items is touched or touched and dragged, a new window at a position where none of the signs of the plurality of items is hidden on the touch panel, and for displaying the sign that has been displayed in the touched item, on the new window.

In the arrangement above, when one of the plurality of items is touched by the user, a new window is opened at a position that hides no sign of any of the plurality of items on the touch panel. The sign displayed in the touched item is displayed in the window. As the sign displayed in the item is displayed in a window separate from the touched item, one can easily confirm where he/she has touched, by the new window. Further, the plurality of other items on the touch panel can clearly be distinguished from the touched item and, therefore, signs included in these items can also be clearly distinguished. As a result, one can reliably touch an item for displaying in a list the intended group of options with a simple operation, and can find the intended option easily.

More preferably, the moving and display means further includes means for displaying, when one of the plurality of items is touched or touched and dragged, signs in a plurality of items displayed adjacent to the touched item, adjacent to the sign displayed in the new window.

In the arrangement above, when one of the plurality of items is touched by the user, signs in a plurality of items displayed adjacent to the touched item are displayed adjacent to the touched sign displayed in the new window. Even if the user erroneously touches an unintended item, signs in items adjacent to the touched item also appear in the new window and, therefore, it is possible for the user to touch again in the new window. As a result, it is robust against a miss in touching, and by a simple operation, an item for displaying a list of intended group of options can reliably be touched and the option can be found.

Preferably, the sign displayed by the first display means is voiceless sound of kana. The user interface device further includes means for storing voiceless sounds, voiced consonants and semi-voiced consonants of kana in a related manner. The second display means includes means for detecting touch-up on the touch panel, and for displaying a list of options having names starting from any of kana in the item corresponding to the touched-up position, voiced consonants and semi-voiced consonants corresponding to the kana, among the plurality of options.

In the arrangement above, when a touch-up from a certain item is found, a list of items having names that start from any of hiragana in the item corresponding to the touched-up position, voiced consonant or semi-voiced consonant corresponding to the hiragana, among the plurality of options, is displayed. Specifically, when an item including a voiceless sound of hiragana is selected, a list of options having names starting from any of the voiceless sounds of hiragana as well as voiced consonant and semi-voiced consonant corresponding to the hiragana is displayed. As a result, a user interface device can be provided in which a list of options having names starting from any of the voiceless sounds of hiragana included in the plurality of items as well as voiced consonant and semi-voiced consonant corresponding to the hiragana can easily be displayed.

More preferably, the user interface device further includes means for highlighting, when one of the plurality of items is touched or touched and dragged, the corresponding item.

In the arrangement above, when one of the plurality of items is touched or touched and dragged, the corresponding item is highlighted. This makes it easier to know which of the items has been touched. As a result, a user interface device can be provided in which a list of options corresponding to a desired sign is efficiently and easily displayed from among the plurality of items.

More preferably, the user interface device further includes means for highlighting the new window, in response to opening of the new window by the moving and display means.

In the arrangement above, when a new window is opened, the window is high-lighted. Therefore, it is easy to know which the newly opened window is, and to determine which item is the object of selection, so that the intended item can reliably be selected. As a result, a user interface device can be provided in which a list of desired options can efficiently be displayed.

Preferably, the first display means includes representative character display means for displaying, on the touch-panel, a plurality of items each including a representative character representing a plurality of characters; and the moving and display means includes display enlarging means for enlarging, when one of the plurality of items including the starting characters is touched or touched and dragged, size of display of the item in the first direction, means for displaying, when one of the plurality of items is touched or touched and dragged, the representative character that has been displayed in the item at a position different from original display position, and display changing means for changing display on the touch panel such that all characters represented by the representative character of the item enlarged by the display enlarging means, and all items displayed by the first display means are displayed on the touch panel.

In the arrangement above, what is displayed on the touch panel at first is only the representative characters. Therefore, the number of characters displayed on the touch panel can be saved, and the screen image is easily viewable. Further, as the touched one among the plurality of items is enlarged, the item can be viewed easily, and hence, one can easily confirm which of the items has been selected. Further, it is common to touch the place where the representative character is displayed, and, as the representative character displayed in the touched item is displayed at a position different from the original display position, it becomes easier to view the representative character of the touched item, allowing easy confirmation. The manner of display on the touch panel is changed such that all characters represented by the representative character of the enlarged item and all items that have been displayed are displayed on the touch panel. Therefore, it becomes easier to select an item corresponding to a character represented by the representative character, and to re-select a representative character other than the representative character of the touched item. Therefore, a user interface device can be provided in which it is possible to easily touch-up a desired item among a plurality of items displayed in a easily viewable manner and a list of options corresponding to the item is displayed.

Preferably, the display changing means includes means for displaying, in the item enlarged and displayed by the display enlarging means, all characters represented by the representative character of the item. The display changing means may include means for displaying a new item at a position adjacent to the item enlarged and displayed by the display enlarging means, and displaying, in the new item, all characters represented by the representative character of the item enlarged and displayed by the display enlarging means. Further, the display changing means may include means for moving, in order to provide a new display area for item display between the item enlarged and displayed by the display enlarging means and an item succeeding the item, the display position of the succeeding item, and for displaying, in the new display area, a plurality of items respectively including characters represented by the representative character in the enlarged and displayed item. Further, the display changing means may include means for dividing each of the plurality of items succeeding the item enlarged and displayed by the display enlarging means to first and second areas, displaying in the first area representative characters that have been displayed in the plurality of items succeeding to the enlarged and displayed item, and in the second area, characters represented by the representative character that has been displayed in the enlarged and displayed item.

In any case, the representative characters and the character represented by the touched item are displayed and, therefore, it is possible to easily select a desired character and to re-select a desired representative character.

According to a second aspect, the present invention provides a computer program causing, when executed by a computer, the computer to operate as any of the user interface devices described above. Therefore, similar effects as those attained by any of the user interface devices described above can be attained.

According to a third aspect, the present invention provides a computer readable recording medium recording the computer program described above.

The foregoing and other objects, features, aspects and advantages of the present invention will become more apparent from the following detailed description of the present invention when taken in conjunction with the accompanying drawings.

### EFFECTS OF THE INVENTION

As can be seen from the foregoing, the present invention provides a user interface device, a program and a recording medium that can easily and appropriately display a list of arbitrary options among a plurality of options for selecting a plurality of functions, allow efficient searching of a desired one among the options, and support increasing number of functions of a user interface for a portable telephone and the like.

### BRIEF DESCRIPTION OF THE DRAWINGS

FIG. 1 is a perspective view of a portable telephone 40 in accordance with a first embodiment of the present invention.

FIG. 2 shows an initial image of a function list search image 60 displayed on a full screen liquid crystal touch panel 56.

FIG. 3 shows a change in item display when the user touches a character “E”.

FIG. 4 shows a change in item display when the user touches the character “E” and thereafter drags his/her finger to “O”.

FIG. 5 shows an example when the user touches the character “E” and moves his/her finger away from “E”.

FIG. 6 shows search items displayed in response to selection of character “E”.

FIG. 7 is a block diagram showing hardware configuration of portable telephone 40 in accordance with the first embodiment.

FIG. 8 is a table showing a character table 74 holding, in the form of a table, character sequence displayed as indexes on portable telephone 40 in accordance with the first embodiment.

FIG. 9 is a table showing a character table 76 holding, in the form of a table, character sequences of voiced consonants and semi-voiced consonants searched from the character displayed on portable telephone 40 in accordance with the first embodiment.

FIG. 10 is a table showing a function dictionary 80 used in portable telephone 40 in accordance with the first embodiment.

FIG. 11 is a flowchart showing a control structure of a computer program realizing portable telephone 40.

FIG. 12 is a flowchart showing a control structure of a computer program realizing the process for changing display of selected area at step 134 of FIG. 11.

FIG. 13 shows a display form of the image when the user touches the character

FIG. 14 shows image transition in the function search method in accordance with a second embodiment.

FIG. 15 is a flowchart representing a control structure of a computer program for realizing the process for changing the display of a selected area in accordance with the second embodiment.

FIG. 16 shows a change in image when the user touches “E”.

FIG. 17 shows image transition in the function search method in accordance with a third embodiment.

FIG. 18 shows an initial image of function searching in accordance with a fourth embodiment.

FIG. 19 shows a change in item display in response to touching by the user.

FIG. 20 shows a change in display when the user selects an item “KA line” and thereafter drags his/her finger to a character in “KA line”.

FIG. 21 shows an image display when a different representative character is changed during a function search.

FIG. 22 shows an image displayed when one drags his/her finger to the item of “SA line” from the state of FIG. 21.

FIG. 23 shows a character set table 220 used in the portable telephone in accordance with a fourth embodiment.

FIG. 24 is a flowchart representing a control structure of a computer program realizing the process for converting display of the selected area in accordance with the fourth embodiment.

FIG. 25 shows image transition in the function search method in accordance with a fifth embodiment.

FIG. 26 shows an image when the user touches “KA line”.

FIG. 27 shows a change in display when the user selects an item “KA line” and thereafter drags his/her finger to a character in “KA line”.

FIG. 28 illustrates an operation when a representative character is focused and member characters are developed in the lateral direction, with a distance of finger movement multiplied by a for focus transition.

FIG. 29 shows a change in display when the user selects the item “KA line” and drags his/her finger to “SA line”.

FIG. 30 shows a change in display when the user selects the item “KA line”, thereafter drags his/her finger to “SA line” and “SASISUSESO” are displayed.

FIG. 31 shows an initial image of function list search image 69 in accordance with a seventh embodiment.

FIG. 32 shows a change in image when the user drags his/her finger from the item “KA line” to item “KA KI KU KE KO”.

FIG. 33 shows a change in image when the user selects an item “KA line” and thereafter drags his/her finger to a character in “KA line”.

FIG. 34 illustrates an operation when a representative character is focused and member characters are developed in the lateral direction, with a distance of finger movement multiplied by a for focus transition.

FIG. 35 shows a change in display when the user selects the item “KA line” and drags his/her finger to “SA line”.

FIG. 36 shows a change in display when the user drags his/her finger from “KA line” to “SA line”.

FIG. 37 illustrates an example of cancelling selection in accordance with the first to seventh embodiments.

FIG. 38 illustrates an example of cancelling selection in accordance with the first to seventh embodiments.

FIG. 39 illustrates an example of cancelling selection in accordance with the first to seventh embodiments.

FIG. 40 illustrates an example of cancelling selection in accordance with the first to seventh embodiments.

FIG. 41 illustrates an example of cancelling selection in accordance with the first to seventh embodiments.

FIG. 42 is a character set table for alphabets.

FIG. 43 shows an appearance of a full screen liquid crystal remote controller.

FIG. 44 shows a selection of a program from an electronic program guide and a display of detailed program information.

FIG. 45 shows selection of a first character of a program title and display of a list of program titles.

FIG. 46 shows an example of display on a portrait screen.

### DESCRIPTION OF THE REFERENCE SIGNS

40 portable telephone, 50 housing, 52 speaker, 54 microphone 56 full screen liquid crystal touch panel, 58 liquid crystal display, 59 electrostatic capacitance type touch panel, 60 function list search image, 70 list of functions, 74 and 76 character tables, 80 function dictionary, 90 antenna, 92 control circuit, 94 vibrating unit, 96 ringer, 98 memory, 110 audio I/F, 112 base band processing unit, 114 RF processing unit, 116 line connecting portion, 118 incoming signal detecting unit, 120 communication control unit, 180 and 190 separate windows, 220 character set table.

### BEST MODES FOR CARRYING OUT THE INVENTION

In the following, embodiments of the present invention will be described in detail with reference to the appended figures.

### First Embodiment

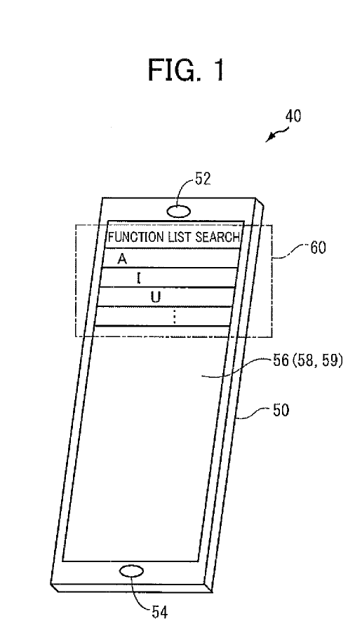

FIG. 1 is a perspective view of a portable telephone 40 as an information processing device in accordance with the first embodiment of the present invention and includes the user interface device in accordance with the first embodiment of the present invention.

Referring to FIG. 1, portable telephone 40 includes a housing 50 of a flat, rectangular parallelepiped shape, a full screen liquid crystal touch panel 56 provided on substantially the entire top surface of housing 50, a speaker 52 and a microphone 54.

Full screen liquid crystal touch panel 56 is a touch panel that also serves as a display, including a liquid crystal display (LCD) 58 and a capacitance type touch panel 59 stacked together.

Speaker 52 and microphone 54 are arranged at an upper side and lower side of full screen liquid crystal touch panel 56 on the upper surface of housing 50.

On full screen liquid crystal touch panel 56) a function list search image 60 is displayed, which is characteristic of the search method adopted in portable telephone 40 in accordance with the present embodiment. Function list search image 60 is an image when portable telephone 40 is used in portrait orientation.

On function list search image 60 displayed on full screen liquid crystal touch panel 56, first, items including characters of 50 Japanese alphabets are displayed, in Japanese alphabetical order. When one's finger touches a portion of full screen liquid crystal touch panel 56 and thereby a position is designated, it outputs coordinate information indicating the designated position. The item specified by the coordinate information is displayed enlarged in the longitudinal direction. Further, full screen liquid crystal touch panel 56 has a function of displaying, when finger contact is lost (touch-up), a list of function names starting from the character displayed on the item corresponding to the position, among the functions supported by the portable telephone 40. By touching an item of a desired function name of the list, the function is activated.

[Outline of Function Search Method]

Details of internal configuration of portable telephone 40 will be described later. First, the function search method in portable telephone 40 in accordance with the present embodiment will be described.

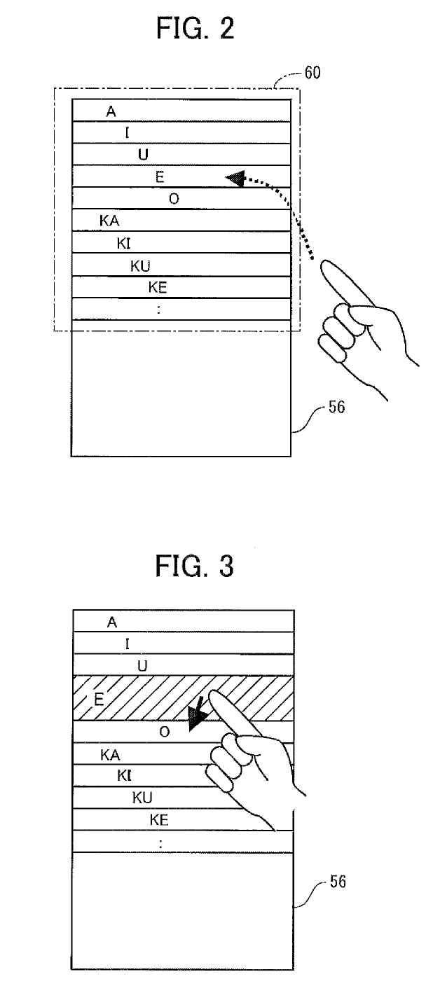

FIGS. 2 to 6 show image transitions in accordance with the function search method of the present embodiment.

FIG. 2 shows an initial image of function list search image 60 displayed on full screen liquid crystal touch panel 56.

Referring to FIG. 2, on function list search image 60, all fifty hiragana characters are displayed in Japanese alphabetical order. Here, assume that the user wishes to adjust brightness of liquid crystal display. Then, the user first touches “F” with his/her finger among fifty hiragana characters, in association with the starting sound of “EKISHONO AKARUSA CHOUSEI” (brightness adjustment of liquid crystal display).

Before the initial image of function list search image 60 shown in FIG. 2 appears, a keyboard having numeric and character keys similar to a keyboard of a common portable telephone, is displayed on full screen liquid crystal touch panel 56. When a search menu is selected from the initial image similar to the common keyboard of a portable telephone, function list search image 60 such as shown in FIG. 2 appears.

FIG. 3 shows a change in display of items when the user touches the character “E”.

Referring to FIG. 3, first, the item “E” is highlighted. Further, the width in the longitudinal direction of the item including the character “E” as the target of the user increases, and at the same time, the character “F” is moved from the original display position and displayed on the left end of the item. Typically, one touches the central portion of an item or the position where the character is displayed. When the character is moved from the original display position to the left end of the item, it follows that the character is not hidden by the finger. Thus, it is advantageous as the selected character is easily viewable. When the character of an item is displayed with its position shifted as shown in FIG. 3, it is possible that the character comes to be hidden by the finger during dragging, even if the character was not hidden when touched. Then, moving the character from the original display position to the left end of the item is advantageous, as the selected character is easily viewable. If an item is smaller than the finger size, it is difficult to select an item. As item is displayed with the width in the longitudinal direction enlarged, selection of the item becomes easier. Therefore, erroneous touching and trouble in touching resulting from finger size can be reduced.

Further, by the touching, the character moves and, at this time, the direction of character movement is changed by determining whether the user operates with his/her right hand or left hand, or by setting in advance with which hand the user operates. Various methods have been generally proposed as the method of determining right hand or left hand operation. By way of example, a technique disclosed in Japanese Patent Laying-Open No, 2006-31518 may be available. Using the technique according to this laid-open application, the determination mentioned above can be attained by allocation based on preset user information, or by inputting the user's dominant hand.

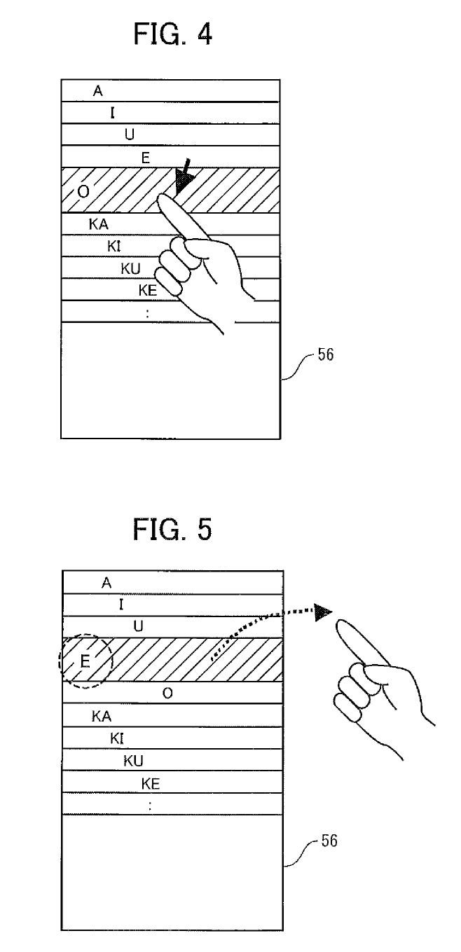

FIG. 4 shows a change in item display when the user touches “O”.

Referring to FIG. 4, if it is the case that the user touched “E” and then wishes to select “O”, he/she has only to drag his/her finger to an item including the character “O” while keeping his/her finger touched on full screen liquid crystal touch panel 56. By this dragging, the longitudinal width of the item including “E” returns to the original size, and the position of “E” also returns to the original position. On the other hand, the longitudinal width of the item including “O” increases, and the character “O” is displayed moved to the left end of the screen. If the user continuously drags to “KA” and “KI” in this order, the display of items at the dragged positions are successively changed in the similar manner.

FIG. 5 shows an example when the user touches “E” and then moves his/her finger away from “E” (hereinafter referred to as “touch-up”).

Referring to FIG. 5, when the finger that has touched “E” is moved away, the item “E” is selected.

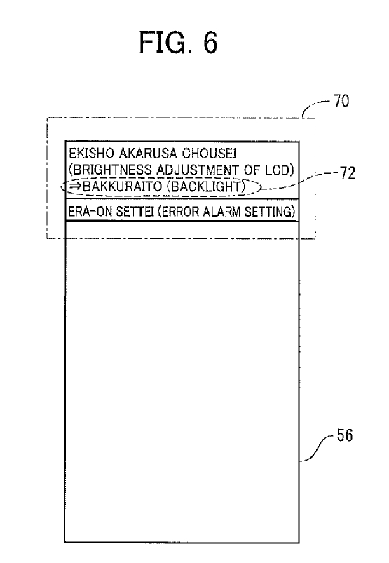

FIG. 6 shows function items displayed in response to the selection of “E”.

Referring to FIG. 6, when the user touches “E” and then touches-up, a list 70 of functions of portable telephone 40 starting from the letter “E” appears on full screen liquid crystal touch panel 56. The user may select the desired function of “EKISHO AKARUSA CHOSEI” (brightness adjustment of liquid crystal display), from function list 70. After the selection of a character, in order to enable search for a function having a name starting from the character, in the present embodiment, a function dictionary table is used, as will be described later. After “EKISHO AKARUSA CHOSEI” (brightness adjustment of liquid crystal display), there is a display of “(→BAKKURAITO (backlight))” 72. “BAKKURAITO” (backlight) is the official name of the function of adjusting brightness of liquid crystal display. As the official name is additionally displayed, the user naturally comes to remember the official function name while using the search function.

[Configuration]

<Hardware Configuration>

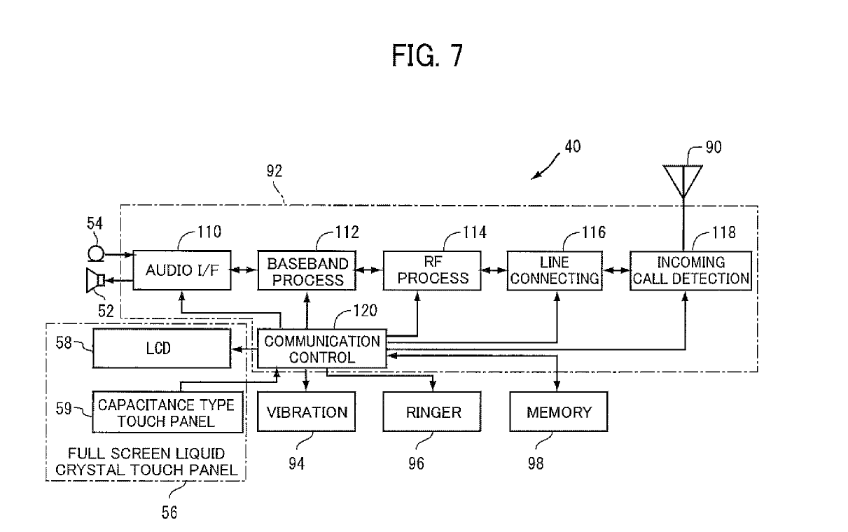

FIG. 7 shows, in a block diagram, hardware configuration of portable telephone 40 in accordance with the present embodiment.

Referring to FIG. 7, portable telephone 40 includes, in addition to speaker 52, microphone 54 and full screen liquid crystal touch panel 56, an antenna 90, a vibration unit 94 for vibrating housing 50 (see FIG. 1) of portable telephone 40, a ringer 96, a non-volatile memory 98, and a control circuit 92.

Control circuit 92 realizes the function of portable telephone 40, the above-described character input function and various other functions, using speaker 52, microphone 54, full screen liquid crystal touch panel 56, antenna 90, vibration unit 94, ringer 96 and memory 98. The control circuit 92 includes an incoming signal detecting unit 118, a line connecting portion 116, an RF (Radio Frequency) processing unit 114, a baseband processing unit 112, and an audio interface (audio I/F) 110, and a communication control unit 120.

Incoming signal detecting unit 118 detects, based on a signal received from a base station through antenna 90, presence/absence of an incoming call from another portable communication terminal at a separate point, and outputs an incoming call detection signal.

Line connecting portion 116 controls on/off of a communication line through antenna 90, in response to a prescribed control signal.

RF processing unit 114 controls intensity of signals exchanged to/from line connecting portion 116 and the base station through antenna 90.

Baseband processing unit 112 performs a prescribed signal processing on a signal to be applied to RF processing unit 114 and a signal received through RF processing unit 114, for safe signal exchange to/from the base station.

Audio I/F 110 has a DA converter and an AD converter, and performed audio input/output through microphone 54 and speaker 52.

Communication control unit 120 controls audio I/F 110, baseband processing unit 112, RF processing unit 114 and line connecting portion 116 in control circuit 92, as well as full screen liquid crystal touch panel 56, vibration unit 94 and ringer 96 outside the control circuit 92, whereby processes outgoing and incoming telephone calls in response to a user request to perform audio communication between the user and another portable communication terminal, performs text communication, or processes a character sequence input by the user. Substantially, communication control unit 120 is formed of a CPU (Central Processing Unit) and software. The software is, in the present embodiment, stored in memory 98, and read and executed by communication control unit 120 as needed. Though not described in detail in the present embodiment, it is possible to rewrite contents in memory 98, and thereby to upgrade and add various functions of portable telephone 40.

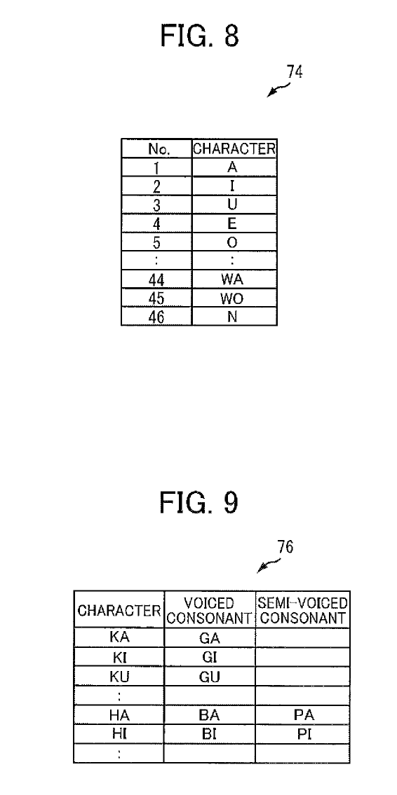

FIG. 8 shows, in the form of a table, a character table 74 for holding, as a table, a character sequence displayed as an index on portable telephone 40 in accordance with the present embodiment. Character table 74 is stored in memory 98 shown in FIG. 7.

Referring to FIG. 8, according to character table 74, the number of characters displayed on function list search image 60 is up to 46. Using character table 74, characters are displayed on function list search image 60.

It is noted that Japanese language includes voiced consonants and semi-voiced consonants. Therefore, not all characters can be displayed on character table 74 shown in FIG. 8. Therefore, in the present embodiment, voiced consonants and semi-voiced consonants corresponding to voiceless sound are also represented and when a voiceless sound is designated, functions having names starting from a voiced consonant or semi-voiced consonant corresponding to the voiceless sound are also displayed on the function list. Therefore, the voiceless sounds and voiced consonants and semi-voiced consonants corresponding to the voiceless sounds are collected in the form of a table, and held in the form of a display table.

FIG. 9 shows a character table 76 for this purpose. Character table 76 is stored in memory 98 shown in FIG. 7.

Referring to FIG. 9, by way of example, voiced consonant “GA” of “KA” corresponds to the character “KA”. Further, voiced consonant “BA” and semi-voiced consonant “PA” correspond to character “HA”. Though an example, in which character sequence displayed as an index is hiragana has been described, a katakana character table prepared in the similar manner may be used if it is katakana.

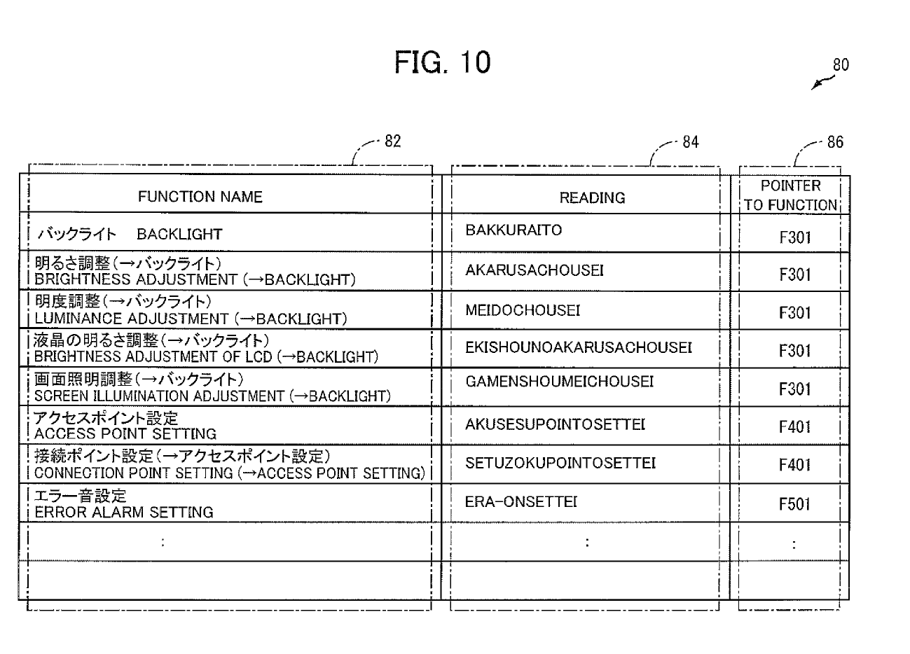

FIG. 10 shows a configuration of a function dictionary 80 used in portable telephone 40 in accordance with the present embodiment. Function dictionary 80 is stored in memory 98 shown in FIG. 7.

Referring to FIG. 10, each item of function dictionary 80 includes a function name 82, readings 84 in hiragana of the function name, and a pointer 86 to a program for realizing the function.

By comparing the character that is touched-up and the starting character of a function stored in the column of readings 84, it is possible to read a function having the same character as the touched one at its head. The function name read by comparison is displayed on full screen liquid crystal touch panel 56.

Pointer 86 to the function is a pointer for accessing to a program for realizing respective function. For instance, if a backlight is to be set, an address of a program for setting brightness of backlight is stored in the pointer.

<Program Structure>

FIG. 1I shows, in the form of a flowchart, a control structure of a computer program realizing portable telephone 40 described above. The program is stored in memory 98 shown in FIG. 7, and executed by a CPU included in communication control unit 120. As a result of execution, each of the above-described functions is realized.

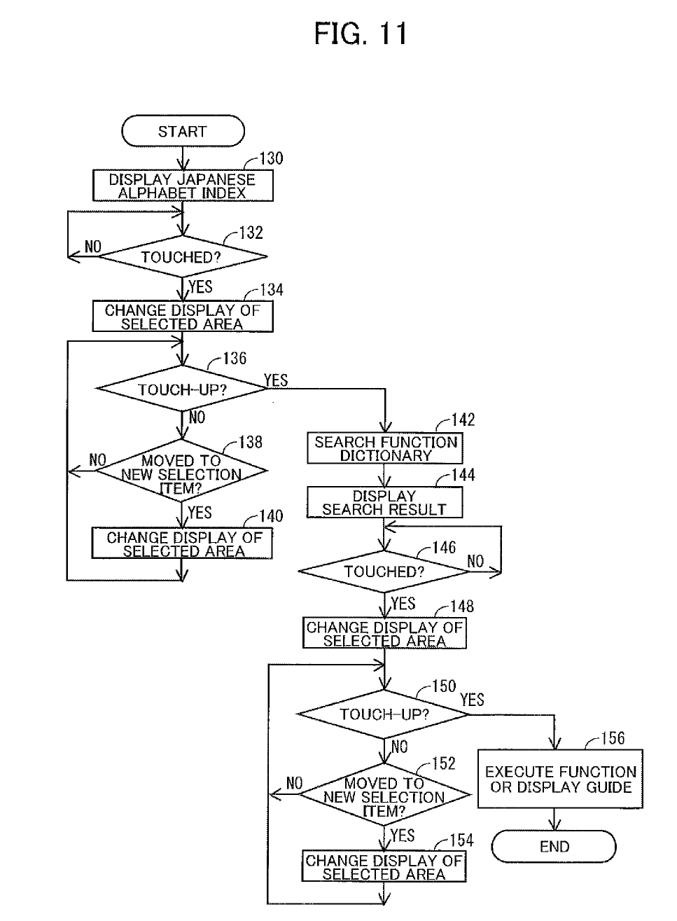

Referring to FIG. 11, the program is activated when the user selects a search menu. At the first step 130, index items are displayed in the order of Japanese alphabet, on full screen liquid crystal touch panel 56.

At step 132, control waits for occurrence of a touch to any of the index items of Japanese alphabet. If any is touched, control proceeds to step 134.

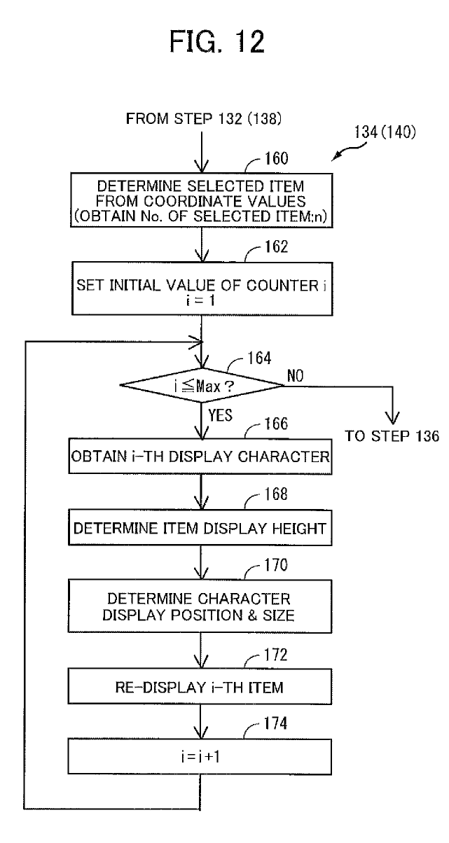

At step 134, display of the item touched and selected at step 132 is changed to highlight display. Details of this process will be described later with reference to FIG. 12.

At step 136, whether there has been a touch-up or not is determined. If there is no touch-up, control proceeds to step 138. If there is a touch-up, control proceeds to step 142.

At step 138, whether or not the user's finger has been kept in touch with full screen liquid crystal touch panel 56 and moved to a new selection item is determined. If it has not moved to a new selection item, control returns to step 136. If it has moved to a new selection item, control proceeds to step 140.

At step 140, a process of changing the display of an item in the selected area to which the user's finger has moved while in touch and changing the highlight display is performed. The process here is the same as that of step 134, and details of the process will be described later with reference to FIG. 12. When the process up to this step ends, control returns to step 136.

At step 142, in response to the user's moving his/her finger away from any of the index of Japanese alphabet, a process for searching, from the function dictionary in memory 98 (see FIG. 7), a function having the character of that item as the starting character of function name reading is performed. At this time, character table 76 shown in FIG. 9 is referred to, and if there is a character of the same group as the touched-up character, functions having the character as the starting character of reading are searched for.

At step 144, a process for displaying the result of searching obtained by the function dictionary searching at step 142 is performed.

At step 146, control waits for any touching by the finger. If there is a touch, control proceeds to step 148.

At step 148, in response to the touching, a process for changing the display of the item including the touched position is performed. Here, the process of changing display is, as already described specifically, to highlight the selected item with its longitudinal width enlarged and to move the character position to the left end of the item.

At step 150, whether there has been a touch-up or not is determined. If there is no touch-up, control proceeds to step 152. If there is a touch-up, control proceeds to step 156.

At step 152, a process for determining whether or not the touched position has been dragged and moved to a new item is performed. If it has not been moved to a new item, control returns step 150. If the touched position has moved to a new item, control proceeds to step 154.

At step 154, a process for changing the display of the item as the destination is performed. The display changing process here is, similar to that of step 148, to highlight the selected item with its longitudinal width enlarged and to move the character position to the left end of the item.

At step 156, in response to the touch-up, the process for realizing the function displayed at the touched-up position is performed. Here, the “process for realizing the function” refers to a process of reading the pointer corresponding to the selected item of function dictionary 80, reading a program from the position indicated by the pointer and executing the program.

FIG. 12 shows, in the form of a flowchart, a control structure of a computer program for realizing the display changing process of the selected area at steps 134 and 140 of FIG. 11.

Referring to FIG. 12, at the first step 160, an index n of the item touched by the user is obtained based on coordinate values, and the item selected by the user is determined.

At step 162, an initial value of variable i, indicating the position of item as the object of display process, is set to i=1.

At step 164, whether the value i is equal to or smaller than the maximum value is determined. Here, the “maximum value” refers to the maximum number of characters held in character table 74 shown in FIG. 8. If i is equal to or smaller than the maximum value, control proceeds to step 166 and, otherwise, to step 136 (see FIG. 11).

At step 166, the i-th display character is obtained from character table 74 stored in memory 98.

At step 168, the width in the longitudinal direction of the item including the i-th character obtained at step 166 is determined. Here, depending on whether the item has been selected by touching or selected by touching followed by dragging, the determined width in the longitudinal direction of the item is made different. If the item has been selected by touching or selected by touching followed by dragging, the width in the longitudinal direction of the item is enlarged. If it is not an item selected by touching or selected by touching followed by dragging, the width in the longitudinal direction of the item is unchanged from the original width.

At step 170, the position of displaying the character, obtained at step 166 and corresponding to the item with its width in the longitudinal direction determined at step 168, is determined. Here, the determined position of displaying the character differs depending on whether the item has been selected by touching or selected by touching followed by dragging. The character included in the item selected by touching or selected by touching followed by dragging is displayed moved to the left end of the item. A character included in an item not selected by touching or not selected by touching followed by dragging is displayed on the original position.

At step 172, the i-th item of which position and size of display are determined at step 170 is displayed again.

At step 174, 1 is added to variable i. Then, the process returns to step 164, and the process steps thereafter are repeated.

[Functions and Effects]

By the user interface device for portable telephone 40 in accordance with the present embodiment, items including Japanese alphabet allowing searching for a function available on portable telephone 40 are displayed on full screen liquid crystal touch panel 56 of a limited area. If the user touches or touches and drags a displayed item, the touched or touched and dragged item is highlighted and has its width in the longitudinal direction made larger. Further, the character is displayed, moved to the left end of the item. By such highlighted display, change in the width in the longitudinal direction of the item and the change in display position of the character, the item is made easily viewable, and considering the size of one's finger, subsequent selection becomes easier. Therefore, a portable telephone 40 that allows efficient and accurate selection of a function can be provided.

In the present embodiment, the character included in the touched or touched and dragged item is displayed on the left end of the item. The character display, however, is not limited to the method of displaying on the left end. For instance, if the user is left-handed, it is easier to view if the character is displayed on the right end of the item. Therefore, it may be preferable to allow, at the stage of initialization before using portable telephone 40, the user to set which of the left and right ends the character should be displayed.

Further, in the present embodiment, the width in the longitudinal direction of the item touched or touched and dragged by the user is displayed larger than others. The number is not limited to one. A plurality of items with the touched or touched and dragged item being the center, may have the longitudinal width made larger than others.

Further, though a function is “executed” in the present embodiment, a function of displaying a description related to the function may also be realized. The “function of displaying a description related to the function” refers to a kind of help function available on a personal computer. Specifically, if the user must operate under some guidance to realize a function, this is the function of displaying the guidance.

### Second Embodiment

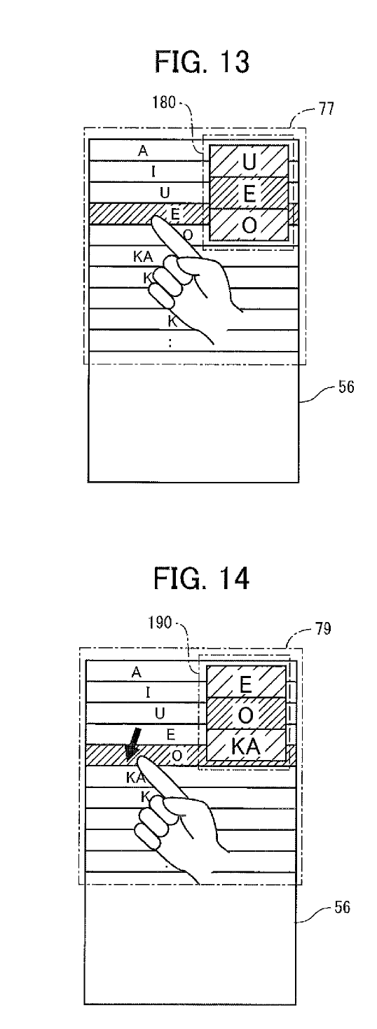

Referring to FIGS. 13 and 14, the second embodiment will be described. The appearance and internal configuration of portable telephone used in the present embodiment are the same as those of the first embodiment. Therefore, description thereof will not be repeated. Further, in the description, the same figures as used for the first embodiment may be referred to.

[Outline of Function Search Method]

The function search method in the portable telephone in accordance with the present embodiment will be described.

FIGS. 13 and 14 show a transition of images in accordance with the function search method of the present embodiment.

FIG. 13 shows an image 77 when the user touches an item “E” on function list search image 60 shown in FIG. 2.

Referring to FIG. 13, three items including the touched item “F” at the center and preceding and succeeding items thereof and characters included in these items are displayed in enlargement on a separate window 180 at an upper right portion of the screen. At the same time, the item “E” and the three items displayed on separate window 180 are highlighted. On the separate window, the item “E” is highlighted in a manner different from other highlighted items.

FIG. 14 shows an image 79 when the user touched the character “E” and thereafter re-selected a character “0”.

Referring to FIG. 14, when the user once touches “E” and thereafter selects “O” as shown in FIG. 13, the user drags his/her finger to the item including “O” with the finger kept touching the full screen liquid crystal touch panel 56. By the dragging, highlight of item “E” disappears and, in place of the separate window 180 (see FIG. 13) that has been displayed, a separate window 190, displaying three items including the touched item “O” at the center and preceding and succeeding items thereof and characters included in these items, is displayed in enlargement at the upper right portion of the screen, as shown by image 79 of FIG. 14. At the same time, the item “O” and the three items displayed on separate window 190 are highlighted.

[Configuration]

<Program Structure>

The program structure for realizing the present embodiment is similar to that shown in FIG. 11. It is noted, however, that the process for changing the display of selected area executed at steps 134 and 140 of FIG. 11 is different.

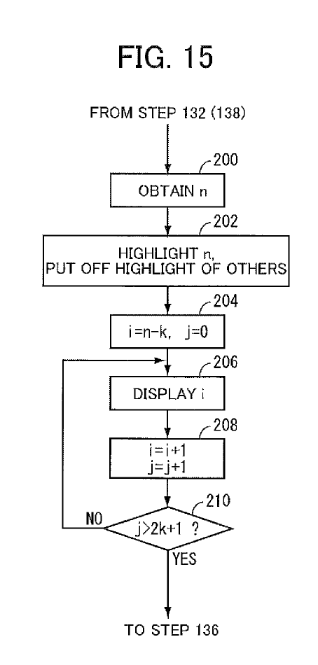

FIG. 15 shows, in the form of a flowchart, a control structure of a computer program for realizing the process for changing the display of selected area, for realizing the present embodiment.

Referring to FIG. 15, at the first step 200, an index n for a touched or touched and dragged item is obtained based on coordinate values.

At step 202, the item indicated by the index n is highlighted, to make the touched item easily viewable. At the same time, highlights of other items are put out.

At step 204, the value of variable i is set to n−k. This is a process for setting an item upper by k from the touched item as the start point of display on the separate window. Further, a value of variable j for controlling subsequent iteration is initialized to 0. As will be made apparent from the following description, n+2k items having the item preceding by k the selected item being the head, will be the object of display on the separate window. In the present embodiment) k=1.

At step 206, the item corresponding to variable i is displayed on the j-th line of the newly opened separate window 180 (see FIG. 13).

At step 208, 1 is added to variables i and j. By this process, the object of processing moves down by one.

At step 210, whether or not the variable j is larger than 2k+1 is determined. If the variable j is larger than 2k+1, control proceeds to step 136 (see FIG. 11). If the variable j is equal to or smaller than 2k+1, control returns to step 206 and the process steps thereafter are repeated.

[Functions and Effects]

By the user interface device for portable telephone in accordance with the present embodiment, items including Japanese alphabet allowing searching for a function available on portable telephone are displayed on full screen liquid crystal touch panel 56 of a limited area. If the user touches or touches and drags a displayed item, the touched or touched and dragged item and items adjacent thereto are displayed in a separate window on an upper right portion of the screen and highlighted. By such highlighted display and enlarged display on a separate window, the item is made easily viewable, and considering the size of one's finger, subsequent drag and touch-up becomes easier. Therefore, a portable telephone that allows efficient and accurate selection of a function can be provided.

In the present embodiment, a separate window is displayed on the upper right portion of the screen. The position of the separate window, however, is not limited to the above. For instance, if the user is left-handed, it is easier to view if the separate window is displayed on the upper left portion of the screen. Therefore, it may be preferable to allow, as initialization of portable telephone, the user to set which of the left and right portions the separate window should be displayed.

### Third Embodiment

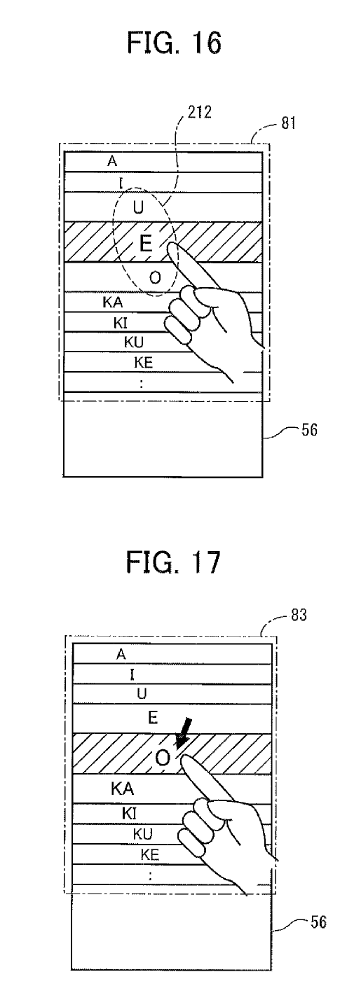

Referring to FIGS. 16 and 17, the third embodiment of the present invention will be described. The appearance and internal configuration of portable telephone used in the present embodiment are the same as those of the first embodiment. Therefore, description thereof will not be repeated here.

[Outline of Function Search Method]

The function search method in the portable telephone in accordance with the present embodiment will be described with reference to FIGS. 16 and 17.

FIG. 16 shows an image 81 when the user touched the character “E”, on function list search image 60 shown in FIG. 2.

Referring to FIG. 16, the display is changed such that width in the longitudinal direction of three items 212 including the touched item “E” at the center and preceding and succeeding items thereof is increased. Here, the width in the longitudinal direction of the item touched by the user (item “E”) is made the largest, while the width in the longitudinal direction of the preceding and succeeding items (items “U” and “O”) are not so much increased as the width in the longitudinal direction of the item touched by the user. Further, the font size included in these items are also increased in accordance with the width in the longitudinal direction of the items. At the same time, the item “E” is highlighted.

Further, if the user touched “E” and then wishes to select “O”, the user drags his/her finger to an item including the character “O” while keeping his/her finger touched on full screen liquid crystal touch panel 56. The display image 83 at this time is as shown in FIG. 17.

Referring to FIG. 17, by the drag mentioned above, three items with the item “O” at the center are displayed in the similar manner as described above.

[Functions and Effects]

By the user interface device for portable telephone in accordance with the present embodiment, items including Japanese alphabet allowing searching for a function available on portable telephone are displayed on full screen liquid crystal touch panel 56 of a limited area. If the user touches or touches and drags a displayed item, width in the longitudinal direction of the touched or touched and dragged item and items adjacent thereto are increased. Further, the touched or touched and dragged item is highlighted. Further, the character is displayed with larger font size. By such highlighted display, change in width in the longitudinal direction of the items and the change in character size, the item is made easily viewable, and considering the size of one's finger, subsequent drag and touch-up becomes easier. Therefore, a portable telephone that allows efficient and accurate selection of a function can be provided.

In the present embodiment, width in the longitudinal direction of three items, including the item touched or touched and dragged by the user at the center and preceding and succeeding items thereof is increased. The number of items, however, is not limited to three. Larger number of items with the touched or touched and dragged item being the center may be displayed with the width in the longitudinal direction increased, and characters included in these items may be displayed in larger size.

### Fourth Embodiment

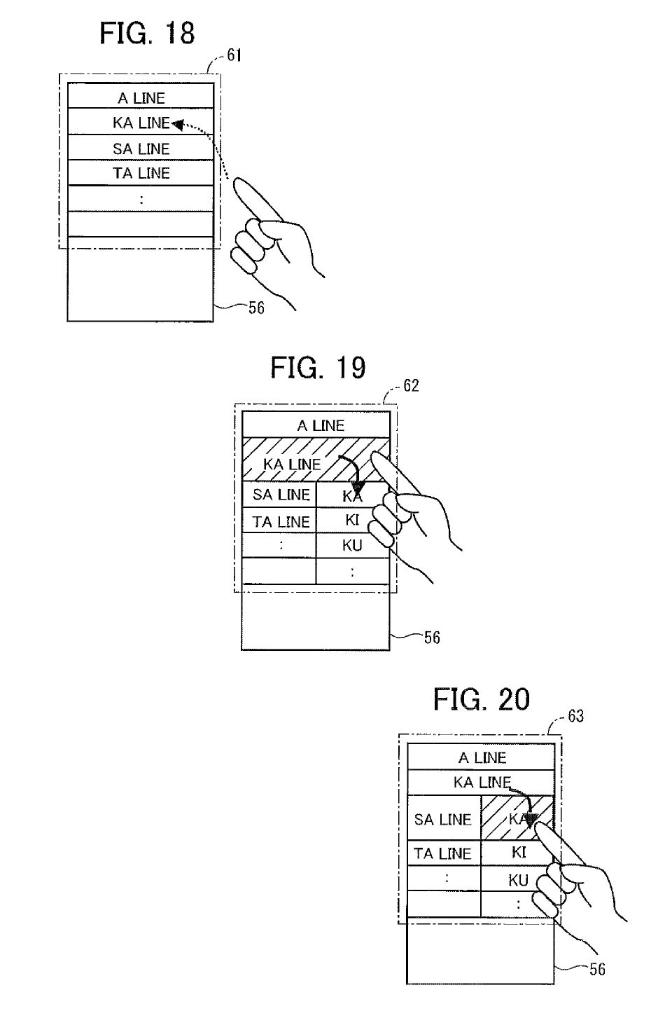

Referring to FIGS. 18 to 22, the fourth embodiment of the present invention will be described. The appearance and internal configuration of portable telephone used in the present embodiment are the same as those of the first embodiment. Therefore, description thereof will not be repeated.

[Outline of Function Search Method]

The function search method in the portable telephone in accordance with the present embodiment will be described with reference to FIGS. 18 to 22.

FIG. 18 shows a function list search image 61 displayed when a search menu is selected from the initial image of the portable telephone.

Referring to FIG. 18, on function list search image 61, starting characters of respective lines “A line”; to “WA line” forming fifty Japanese alphabet are displayed. In the following, these characters will be referred to as “representative characters.” Here, assume that a function having a character of “KA line” as the starting character of its name is to be searched. In that case, the user touches the item “KA line.”

FIG. 19 shows a function list search image 62 displayed on full screen liquid crystal touch panel 56 in response to touching by the user.

Referring to FIG. 19, the item “KA line” is highlighted. The width in the longitudinal direction of item “KA line” is enlarged. Further, five items below the touched item are divided to left and right, and characters “KA KI KU KE KO” included in “KA line” are displayed in this order on the right half of the items. On the left side of respective items, lines following “SA line” remain displayed. From the item immediately below the last character “KO” of “KA KI KU KE KO” displayed on the right half, division into two is not performed, and only the representative characters of respective lines are displayed.

In order to search for a function of which starting character is any of “KA” to “KO”, the user drags his/her finger to the desired item among “KA” to “KO” displayed on the right half of the image and touches-up, as shown by the arrow in FIG. 19. FIG. 20 shows an image 63 that appears by the drag operation.

Referring to FIG. 20, in the image 63, the width in the longitudinal direction of item “KA line” is returned to the original width, and the highlight is put out. Then, the width in the longitudinal direction of the item as the destination of dragging is increased and the item is highlighted. For instance, if a list of functions starting with “KA” is to be displayed, the user may drag his/her finger to the item “KA” displayed on the right side of the image and may touch-up there. When the user drags his/her finger to the item “KA”, the width in the longitudinal direction of item “KA” increases and, therefore, reliable touch-up becomes possible.

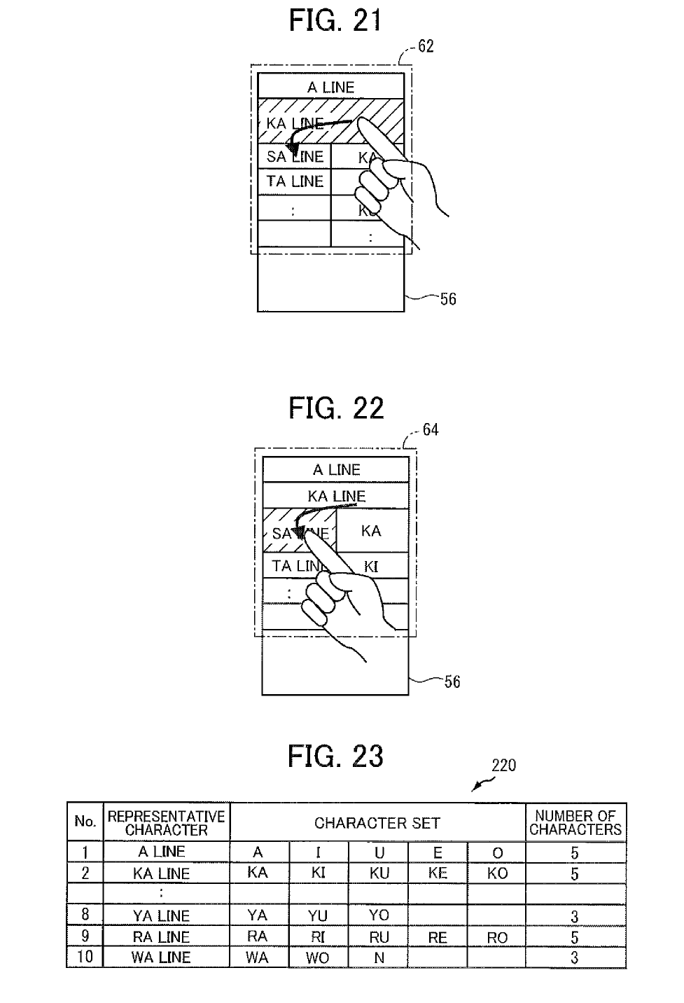

FIG. 21 shows an image 62 when a line different from once touched line is selected during function searching.

Referring to FIG. 21, in this case, as represented by the arrow, one drags his/her finger from the item “KA” to the desired item among the items starting from “SA line” on the left side.

FIG. 22 shows an image 64 displayed when one drags his/her finger to item “SA line” from the state of FIG. 21.

Referring to FIG. 22, when one drags his/her finger to the item “SA line” on image 64, the width in the longitudinal direction of item “KA line” is returned to the original width, and the highlight is put out. The width in the longitudinal direction of item “SA line” increases. At the same time, the item “SA line” is highlighted. Though not shown in FIG. 22, five items immediately following the item “SA line” are divided to left and right. Consequently, representative characters of respective lines are displayed on the left side, and five characters belonging to “SA line” are displayed on the right side.

FIG. 23 shows, in the form of a table, a character set table 220 storing representative characters used in the portable telephone in accordance with the present embodiment and character set represented by any of the representative characters. Character set table 220 is stored in memory 98 shown in FIG. 7.

Referring to FIG. 23, character set table 220 includes ten character sets of hiragana characters of “A line” to “WA line”. The representative character of each character set is the starting character of each line. In the present embodiment) for each character set of character set table 220, the number of characters included in the character set is stored.

[Configuration]

<Program Structure>

The control structure of the overall program for realizing the embodiment is similar to that shown in FIG. 11. It is noted, however, that in place of the process of changing display of the selected area at steps 134 and 140 of FIG. 11, a process for realizing the image transition shown in FIGS. 18 to 22 is necessary.

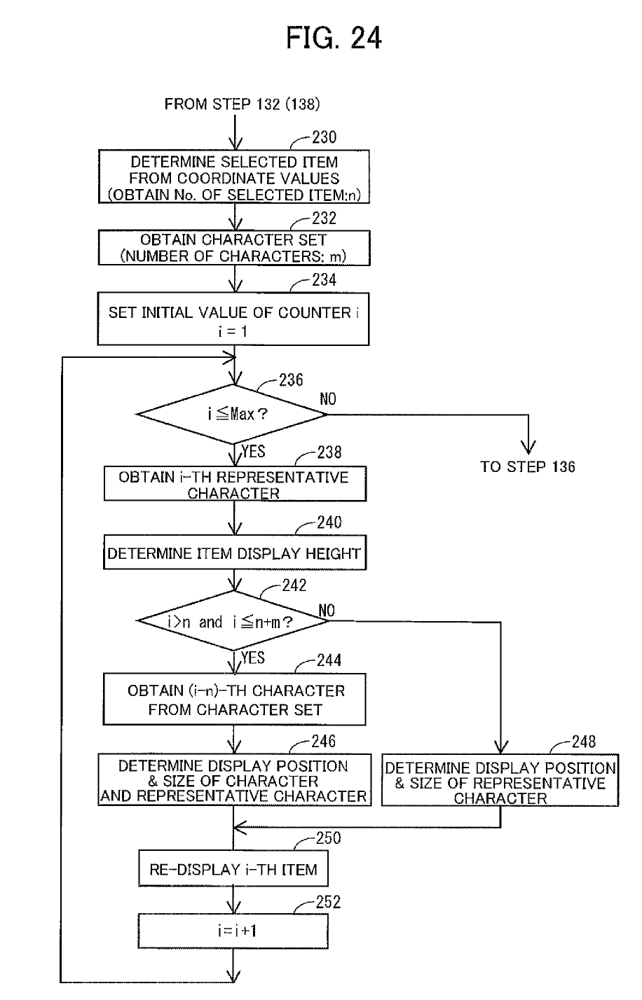

FIG. 24 shows, in the form of a flowchart, a control structure of a computer program for realizing the process for changing display of the selected area in accordance with the fourth embodiment.

Referring to FIG. 24, at the first step 230, an index n for a touched or touched and dragged item is obtained based on coordinate values.

At step 232, from the character set table 220 (see FIG. 23) stored in memory 98 (see FIG. 7), a character set determined by the index n obtained at step 230 is obtained. Here, it is assumed that the number of characters of the obtained character set is m. The number of characters can be obtained from character set table 220.

At step 234, an initial value of variable i, indicating the position of item as the object of display process, is set 1.

At step 236, whether the value i is equal to or smaller than the maximum value is determined. Here, the “maximum value” refers to larger one of the number of items in the initial state and n+m. If the maximum number is equal to or smaller than the maximum value, control proceeds to step 238, and if not to step 136 (see FIG. 11).

At step 238, i-th representative character is obtained from character set table 220 stored in memory 98.

At step 240, the width in the longitudinal direction of the item including the i-th character obtained at step 238 is determined. Here, depending on whether the item has been selected by touching or selected by touching followed by dragging, the determined width in the longitudinal direction of the item is made different. If the item has been selected by touching or selected by touching followed by dragging, the width in the longitudinal direction of the item is enlarged. Otherwise, the width is determined to be the ordinary width.

At step 242, whether i>n and i≦n+m is determined. If i>n and i≦n+m control proceeds to step 244, and otherwise, to step 248.

At step 244, the (i−n)-th character is obtained from the character set obtained at step 232. This is a process of obtaining the character as the object of display, from the character set having the character selected by the user as the representative item.

At the following step 246, the position of displaying the character obtained at step 244 and representative character obtained at step 238, as well as the display size of these characters are determined. Here, the item is divided to left and right. The character obtained at step 244 is displayed on the right side item, and the representative character obtained at step 238 is displayed on the left side item of the image.

At step 248, the position and size of display of only the representative character obtained at step 238 are determined. Here, the representative character is displayed at the center of the item extending from the right end to the left end of the image.

At step 250, the i-th item is again displayed.

At step 252, 1 is added to variable i. Then, control returns to step 236.

[Functions and Effects]

By the user interface device for portable telephone in accordance with the present embodiment, only representative characters are displayed on full screen liquid crystal touch panel 56 of a limited area. If the user touches the displayed item, the width in the longitudinal direction of the touched item is increased, and the representative character in the item is highlighted. Further, a prescribed number of items below the touched item are divided to left and right, and character set having the touched character as the representative character is displayed on the right side of the item and representative characters following the touched representative character are displayed on the left side of the item.

By such highlighted display and the change in display position, the following advantages are attained.

(1) Only the representative characters are displayed on the initial image and, therefore, items can occupy large area, allowing easy touching.

(2) When a prescribed representative character is touched, the width in the longitudinal direction of the item including the representative character is increased, and only the character group belonging to the representative character is fully displayed. Therefore, here again, items can occupy large area, allowing easy touch-up. Further, the corresponding item is highlighted for easier viewing.

(3) As the item can occupy a large area, each item is easily viewable, resulting in smaller number of errors.

From the foregoing, portable telephone that allows efficient and accurate searching of a function can be provided.

In the present embodiment, when a prescribed representative character is touched, following representative characters are displayed on the right side of the image and the character group belonging to the touched representative character is displayed on the right side. The left and right display is not limited to the above. By way of example, the representative characters may be displayed on the right side of the image and the character group may be displayed on the left side of the image.

### Fifth Embodiment

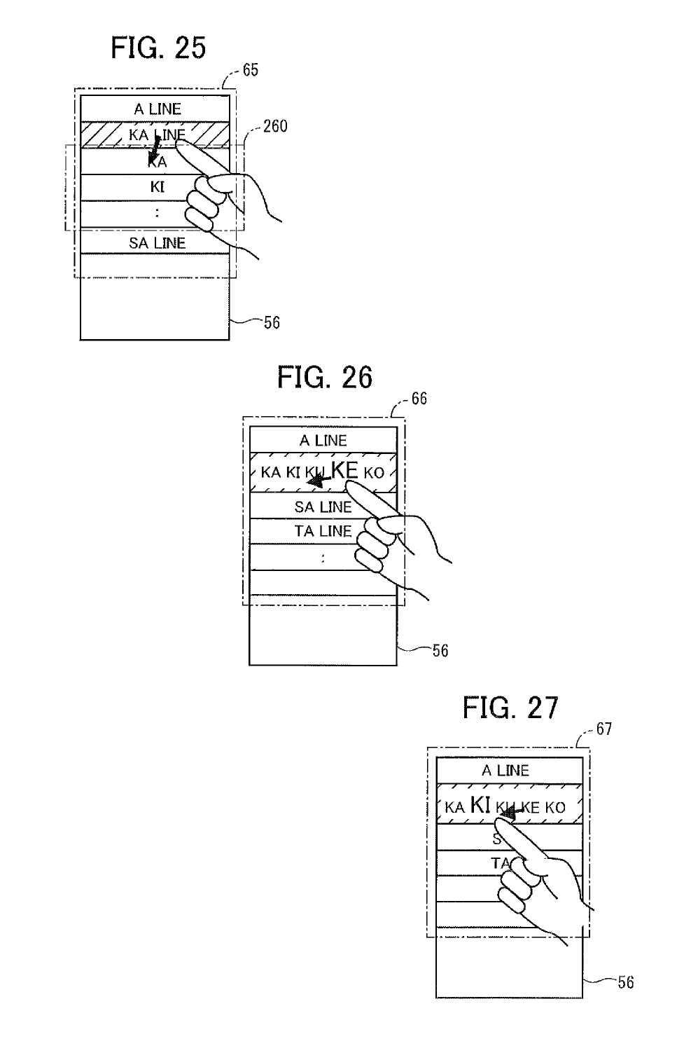

Referring to FIG. 25, the fifth embodiment of the present invention will be described. The appearance and internal configuration of portable telephone used in the present embodiment are the same as those of the first embodiment, and the program structure is the same as the fourth embodiment. Therefore, description thereof will not be repeated.

[Outline of Function Search Method]

The function search method in the portable telephone in accordance with the present embodiment will be described.

FIG. 25 shows an image transition in accordance with the function search method of the present embodiment. The initial image of function list search image of the present embodiment is the same as that shown in FIG. 18. When the user touches an item “KA line” in FIG. 18, the image changes to the image 65 of FIG. 25.

Referring to FIG. 25, on image 65, the touched item “KA line” is highlighted, the item “SA line” moved downward by a prescribed amount, and a space 260 corresponding to 5 lines appear between the item “KA line” and the following item “SA line”. In the space 260, character group “KA KI KU KE KO” belonging to the “KA line” is displayed. Here, if the user wishes to search for a function having the name starting from the character “KI”, he may drag his/her finger to the item including “KI” and touch-up there.

[Functions and Effects]

By the user interface device for portable telephone in accordance with the present embodiment, only representative characters are displayed on full screen liquid crystal touch panel 56 of a limited area. If the user touches a displayed item, a set of characters represented by the representative character included in the touched item is displayed in a plurality of items immediately following the item on which the representative character is displayed. By dragging one's finger to the desired item among these and touching-up at the item, a list of functions of which names start from the character of the item is displayed. The touched item and the item at the destination of dragging are highlighted.

By such highlighted display and the change in display, the following advantages are attained.

(1) Only the representative characters are displayed on the initial image and, therefore, items can occupy large area, allowing easy touching.

(2) When a prescribed representative character is touched, all characters of the character group belonging to the representative character are displayed, one by one on item by item. As one character is displayed on one item, it is possible to drag to the desired item and to touch-up at an accurate position.

(3) By the display method described above, the character can be displayed in large size and, therefore, the character is easily viewable. Further, highlighted display also makes the item easily viewable.

From the foregoing, portable telephone that allows efficient and accurate searching of a function can be provided.

### Sixth Embodiment

Referring to FIGS. 26 to 29, the sixth embodiment of the present invention will be described. The appearance and internal configuration of portable telephone used in the present embodiment are the same as those of the first embodiment. Therefore, description thereof will not be repeated.

[Outline of Function Search Method]

The function search method in the portable telephone in accordance with the present embodiment will be described.

The initial image of function list search image of the present embodiment is the same as that shown in FIG. 18. When the user touches an item “KA line” in the state of FIG. 18, the image changes to the image 66 of FIG. 26.

Referring to FIG. 26, the character group “KA KI KU KE KO” belonging to the touched item “KA” is displayed in highlight, on the item on which “KA line” has been displayed. At this time, the width in the longitudinal direction of item “KA KI KU KE KO” is enlarged, and the character (for example, “KE”) touched by the user's finger is displayed larger than other characters. When the user drags his/her finger on the item “KA KI KU KE KO” as represented by the arrow in FIG. 26, the character that is displayed large changes in accordance with the dragged position.

FIG. 27 shows an image 67 when the user dragged his/her finger to the character “KI”. Here, the character “KI” is displayed large, while the character “KE” is changed to the ordinary size. If the user wishes to search for a function having the name with the starting character “KI”, he/she may move his/her finger in this state.

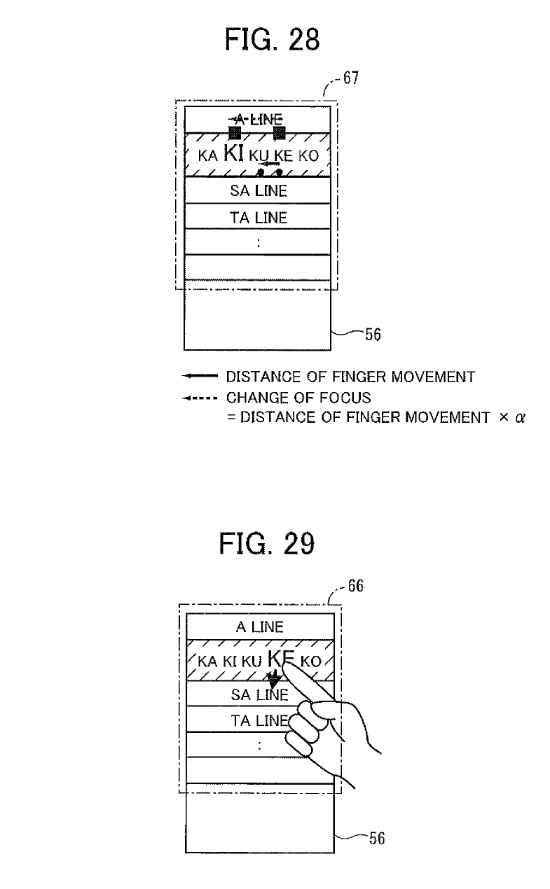

As described above, when the representative character (“KA line”) is focused, the member characters (“KA KI KU KE KO”) belonging to the representative character are developed in the lateral direction. At this time, when the finger is moved in the lateral direction, the focus is changed by the distance α times the distance of finger movement, as shown in FIG. 28 (in the present embodiment, α=3). By such an operation, it becomes possible to select the target object with just a slight movement of one's finger on the member characters developed in the lateral direction in connection with the focused representative character.

If the user wishes to search for a function having the name starting from any character of “SA line” rather than “KA line”, the following operation is done.

FIG. 29 again shows the image 66 of FIG. 26. Here, the user drags his/her finger from the item “KA KI KU KE KO” to the item of “SA line” and the following items below, as represented by an arrow in FIG. 29.

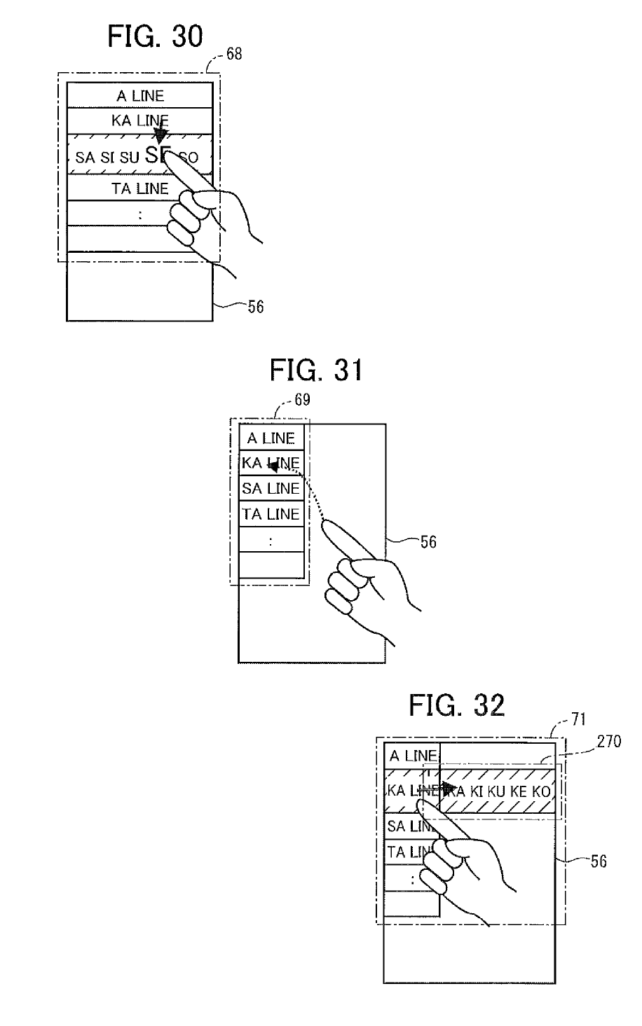

FIG. 30 shows an image 68 after the user dragged hi/her finger to item “SA line”.

Referring to FIG. 30, when the user drags his/her finger to item “SA line”, the characters “SA SI SU SE SO” belonging to the character group of “SA line” are displayed highlighted on the item on which the item “SA line” has been displayed. The display of item on which characters “KA KI KU KE KO” has been displayed is returned to item “KA line”, the width in the longitudinal direction of the item returns to the original width, and highlight is put out. On the other hand, the width in the longitudinal direction of item “SA SI SU SE SO” is enlarged, and the character touched by the user's finger (for example, “SE”) is displayed larger than other characters of “SA line”. When the user drags his/her finger further down, similar display appears for the item “TA line” and following items.

[Functions and Effects]

By the user interface device for portable telephone in accordance with the present embodiment, representative characters are displayed on full screen liquid crystal touch panel 56 of a limited area. If the user touches a displayed item, a set of characters represented by the representative character included in the touched item is displayed in highlight. The width in the longitudinal direction of the item is also increased significantly.

By such highlighted display and the change in display, the following advantages are attained.

(1) Only the representative characters are displayed on the initial image and, therefore, items can occupy large area, allowing easy touching.

(2) When a prescribed representative character is touched, all characters of only the character group belonging to the representative character are displayed in one same item, and the character that corresponds to the position touched by the finger is displayed larger than other characters. Therefore, one can move his/her finger at a position accurately designating a character.

From the foregoing, portable telephone that allows efficient and accurate searching of a function can be provided.

### Seventh Embodiment

Referring to FIGS. 31 to 36, a seventh embodiment of the present invention will be described. The appearance and internal configuration of portable telephone used in the present embodiment are the same as those of the first embodiment. Therefore, description thereof will not be repeated.

[Outline of Function Search Method]

The function search method in the portable telephone in accordance with the present embodiment will be described.

FIG. 31 shows an initial image 69 of the function list search image of the portable telephone in accordance with the present embodiment.

Referring to FIG. 31, on the left end of image 69, a plurality of items are displayed, each displaying one of the representative characters of 50 Japanese alphabets. The user touches a representative character of a character group, to which the starting character of the function to be searched belongs. Assume, for example, that the user wishes to search for a function of which name starts with the character “KI”. Here, the character group to which “KI” belongs is “KA line” and, therefore, the user touches the item “KA line” on image 69. As a result, an image 71 shown in FIG. 32 appears on full screen liquid crystal touch panel 56.

Referring to FIG. 32, when the user touches any of the items, on the right side of the touched item (for example, item “KA line”), an item 270 including the character group (for example, “KA KI KU KE KO”) having the character of the item as the representative character is displayed. Further, the item “KA line” and item 270 are enlarged in the longitudinal direction, that is, the width in the longitudinal direction is increased, and the items are highlighted. Items “KA line” and 270 are continuous and, it is possible to drag one's finger from item “KA line” to item 270 as represented by the arrow.

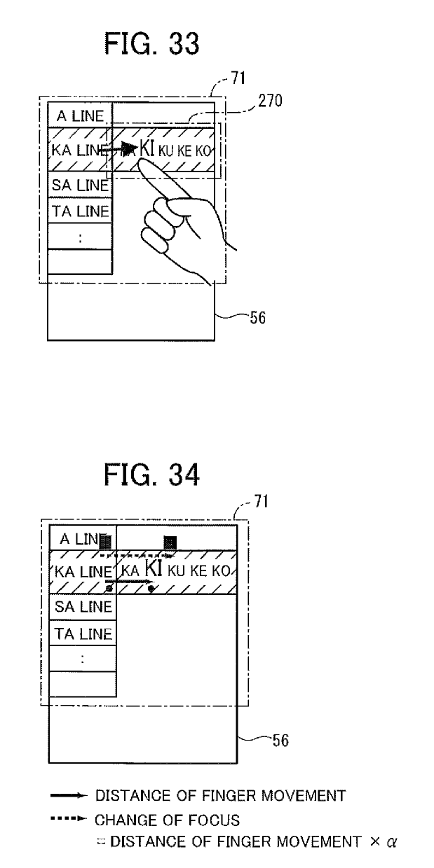

FIG. 33 shows an image 71 when the user dragged his/her finger from that state of FIG. 32 to the position of character “KI” in item 270.

Referring to FIG. 33, the character to which the user dragged is displayed larger than other characters. As the position of dragging changes, the character that is displayed large changes. As the user drags his/her finger to the position of desired character and touches-up at that position) a list of functions having the desired character as the starting character of their names is displayed on full screen liquid crystal touch panel 56. For instance, if the user wishes to search for a function of which starting character is “KI”, he/she may drag his/her finger from the position where “KA line” is displayed to “KI” in item 270 and touch-up at that position.

As described above, when the representative character (“KA line”) is focused, the member characters (“KA KI KU KE KO”) belonging to the representative character are developed in the lateral direction. At this time, when the finger is moved in the lateral direction, the focus is changed by the distance α times the distance of finger movement, as shown in FIG. 34 (in the present embodiment also, α=3). By such an operation, it becomes possible to select the target object with just a slight movement of one's finger on the member characters developed in the lateral direction in connection with the focused representative character.

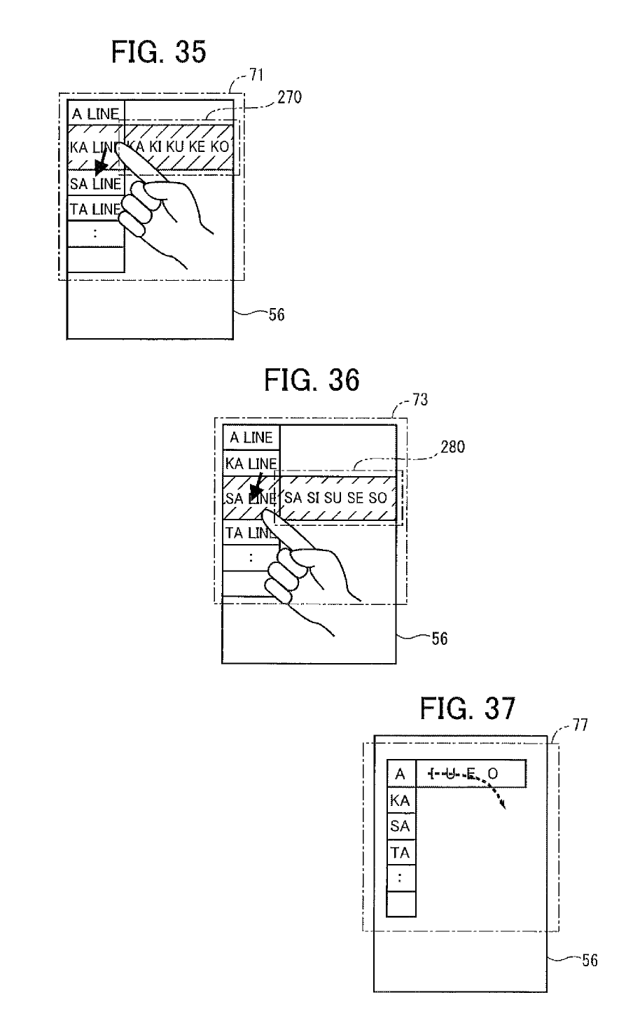

FIG. 35 shows finger movement when the user wishes to search for a function having the name starting from a character of “SA line” rather than “KA line”.

Referring to FIG. 35, assume that the user once selects the item “KA line” on image 71 and thereafter, comes to wish to select a function that starts from a character included in item “SA line”. In that case, he/she drags his/her finger from item “KA line” to item “SA line” while keeping his/her finger touched on full screen liquid crystal touch panel 56. As a result, the display of full screen liquid crystal touch panel 56 is changed to an image 73 shown in FIG. 36.

Referring to FIG. 36, when the user drags his/her finger to item “SA line”, on the right side of item “SA line”, an item 280 including the character group “SA SI SU SE SO” having the character “SA” as the representative character is displayed. The item 270 on the right side of item “KA line” (see FIG. 35) disappears, the width in the longitudinal direction is returned to the original size, and highlight is put out. Then, the width in the longitudinal direction of item “SA line” is increased and the item is highlighted. Item 280 also comes to have similar width in the longitudinal direction and is highlighted. If the user wishes to search for a function having any of the characters of “SA SI SU SE SO” as the starting character of its name, he/she may drag his/her finger from the state shown in FIG. 36 to the position of the corresponding character, and touch-up at that position.

[Functions and Effects]

By the user interface device for portable telephone in accordance with the present embodiment, representative characters are displayed on full screen liquid crystal touch panel 56 of a limited area. When the user touches any of the displayed items, an item including a character set represented by the representative character included in the touched item is displayed on the right side of the item including the representative character, and highlighted. Representative characters other than the touched representative character are kept displayed on the left end of the image. Further, the item including the touched representative character is enlarged in the longitudinal direction, the width in the longitudinal direction is made larger than others, and the width in the longitudinal direction of the item displayed on the right side is also increased in the similar manner.

By such highlighted display, the change in display position and the change in width in the longitudinal direction, the following advantages are attained.

(1) Only the representative characters are displayed on the initial image and, therefore, items can occupy large area, allowing easy touching of the desired item.

(2) When a representative item is touched, only the characters belonging to the character set corresponding to the representative character are all displayed on the right side of the item including the representative character. Among these, the character at a position touched by the user is displayed larger than others. Therefore, the item is easily viewable, allowing the user to touch-up at an accurate position, and a desired character can reliably be selected.

(3) The touched item is highlighted and, therefore it is possible to accurately know which item is touched.

From the foregoing, a portable telephone that allows efficient and accurate searching of a function can be provided.

In the present embodiment, the representative characters are displayed on the left end of full screen liquid crystal touch panel 56. When any of the representative characters is touched, the characters belonging to the character group represented by the representative character are displayed on the right side of the item displaying the representative character. The manner of display, however, is not limited to the above. For instance, the representative characters may be displayed on the right end of the image, and the character group may be displayed on the left side of the item displaying the representative character.

Though the search function has been described using the representative characters of respective lines of 50 Japanese hiragana characters as representative signs, representative character sequence representing characters such as shown in FIG. 42 may be used as the representative signs.

FIGS. 37 to 41 shows a manner of cancelling selection, in the first to seventh embodiments.

In the example shown in FIG. 37, when one moves his/her finger away from the display area on image 77, selection is cancelled at that moment.

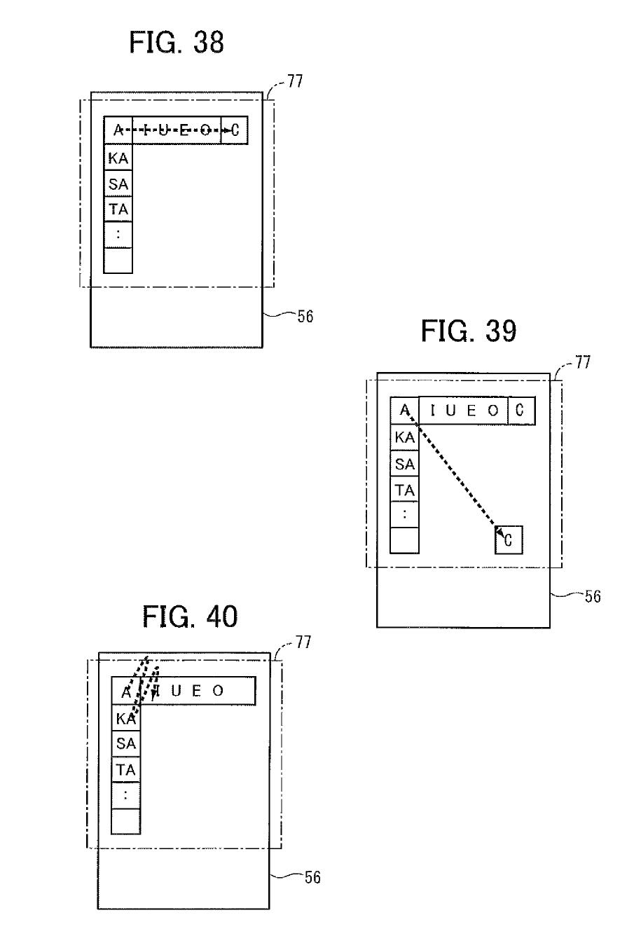

In the example shown in FIGS. 38 and 39, when one moves his/her finger to a cancel area C originally displayed on image 77 from the display area (that is, when one focuses his/her finger to cancel area C), the selection is canceled. In FIG. 38, cancel area C is provided continuous from an end portion of member characters in the display area, on image 77. In FIG. 39, cancel area C is provided at a position away from the display area.

In the example shown in FIG. 40, selection is canceled by a cancel gesture, such as a number of zigzag reciprocating movements of one's finger on the display area of image 77.

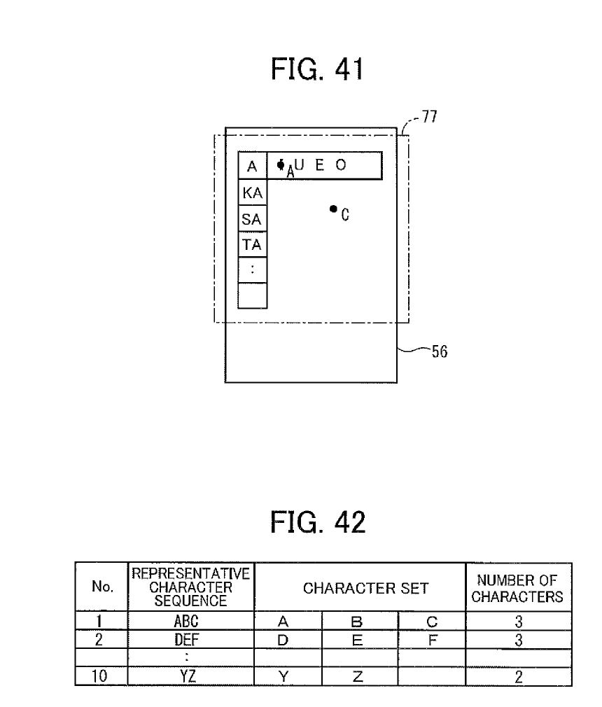

In the example shown in FIG. 41, when point A is being focused on the display area of image 77 and an arbitrary point C away from the display area is touched by another finger, the focus (selection) is cancelled in response to the touching of these two points.

The present invention is not limited to the embodiments described above.

(1) In the embodiments described above, one uses his/her finger for touching. It is possible to use a tool such as a pen rather than one's finger. Other tool may be used for touching.

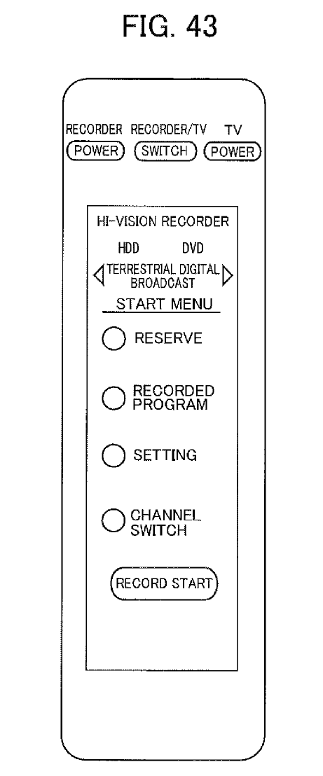

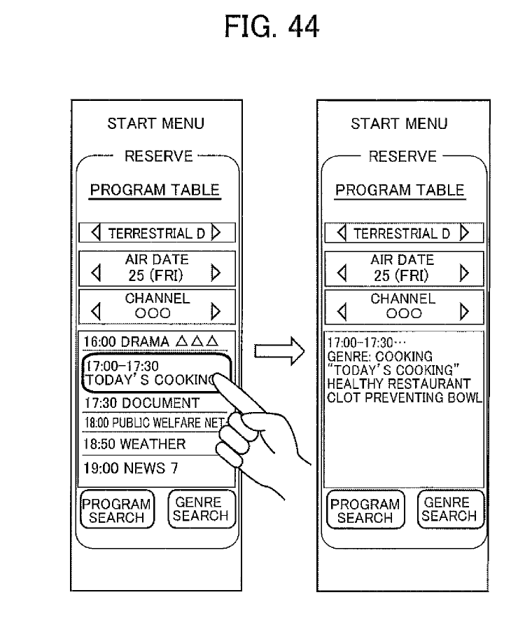

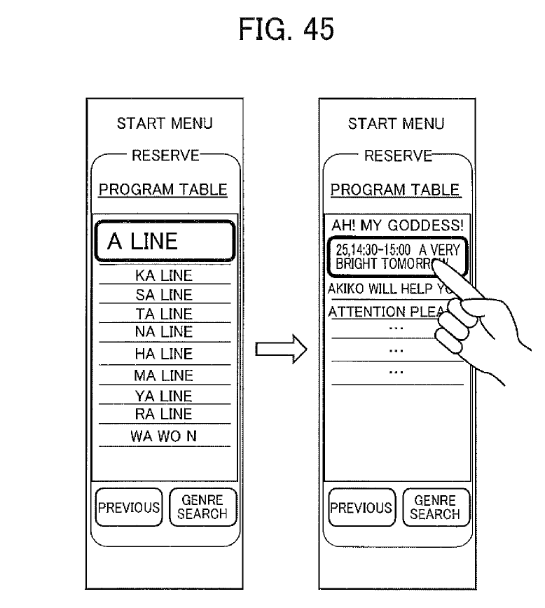

(2) In the embodiments described above, search function has been described using a portable telephone. The equipment having the search function is not limited to a portable telephone. By way of example, a remote controller such as shown in FIG. 43 or other terminal, having a touch panel similar to full screen liquid crystal touch panel 56 may be used. FIG. 44 shows an image displaying detailed information (related information) of a program using an electronic program guide (EPG), on a remote controller shown in FIG. 43. When a user touches a list of program titles, related information is displayed on the item at the touched position, and when dragged, display at the item at the dragged position changes successively to related information. As can be seen from FIG. 44, if a list of program titles is shown on a screen of the remote controller, there may arise a problem that only a part of the title can be displayed, for example, “18:00 Public Welfare Net . . . ” Therefore, the width in the longitudinal direction of the item at the position touched by the finger is enlarged, and at the same time, more detailed information is displayed. Thus, the user can obtain much information, and selection of the item is facilitated. When the user touches-up at the position of the desired program title, the detailed information of the program is displayed. The related information may include execution of a function on the selected program (such as reservation or program switch), in addition to the information related to the selected program. FIG. 45 shows an image for searching, using the starting character of the program title, on the electronic program guide.

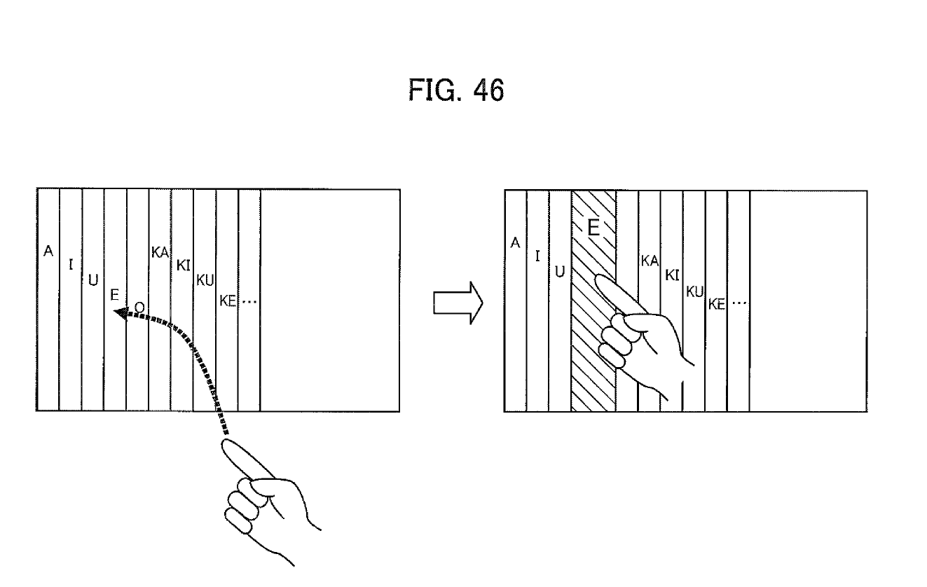

(3) In the embodiment described above, the search function has been described using a display image of portrait layout. The present invention is also applicable when a display image of landscape layout is used, as shown in FIG. 46.

(4) The touch panel is not limited to one using liquid crystal, and ones using other display device may also be available. Further, not only the capacitance type touch panel but also other types, such as pressure sensitive type panel, may be used as the touch panel.

(5) In the embodiment above, the function selected by the above-described method from the function list is actually executed. The present invention, however, is not limited to such a configuration. For example, it may be applied to any application for searching a desired one from a plurality of objects of selection, such as a function of displaying a help for each function.

(6) The embodiments above are related to a device displaying hiragana, allowing searching for a function having a hiragana as the starting character of its name. The present invention, however, is not limited to such a configuration. The present invention is applicable to any device for selecting a desired item from a plurality of items using a touch panel for that purpose. By way of example, it is possible to designate a desired character from katakana, alphabets and the like, and to select an item having the character as the starting character of its name.

(7) The present invention is also applicable when a number of icons are displayed on a touch panel and an icon corresponding to a desired item is selected in hierarchical manner or in one layer.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

### INDUSTRIAL APPLICABILITY

The present invention is capable of easily and appropriately display a list of arbitrary options among a plurality of options and allows efficient searching of a desired one among the options, while supporting increasing number of functions of, for example, a portable telephone. Therefore, it is useful in all equipment having a user interface device.

1-19. (canceled)

20. A user interface device, comprising:
first display means for displaying a plurality of items each including a sign, on a touch panel having a display function;
moving and display means for displaying, when one of said plurality of items is touched or touched and dragged, the sign of the corresponding item at a position different from original display position; and
a second display means for detecting a touch-up on said touch panel and displaying a list of options of a prescribed relation with the sign in, or related information of, an item corresponding to the touched-up position, among a plurality of options prepared in advance.

21. The user interface device according to claim 20, wherein
said moving and display means includes means for successively changing, when touched and thereafter dragged, display of a sign of the corresponding item in accordance with the dragged position.

22. The user interface device according to claim 20, wherein
said first display means includes means for displaying, on said touch panel, said plurality of items along a prescribed first direction, and displaying, in each item, the sign of the corresponding item at a position different from a sign of an adjacent item, in a second direction intersecting said first direction.

23. The user interface device according to claim 20, wherein
said moving and display means includes means for enlarging, when one of a plurality of items arranged along a prescribed first direction on said panel is touched or touched and dragged, size of display of said item in said first direction, and moving and displaying a sign has been displayed in said item to an end portion of said item.

24. The user interface device according to claim 20, wherein
said moving and display means includes means for opening, when one of the plurality of items is touched or touched and dragged, a new window at a position where none of the signs of said plurality of items is hidden on said touch panel, and for displaying the sign that has been displayed in said touched item, on the new window.

25. The user interface device according to claim 24, wherein
said moving and display means further includes
means for displaying, when one of the plurality of items is touched or touched and dragged, signs in a plurality of items displayed adjacent to said touched item, adjacent to the sign displayed in said new window.

26. The user interface device according to claim 20, wherein
the sign displayed by said first display means is voiceless sound of kana;
said user interface device further comprising
means for storing voiceless sounds, voiced consonants and semi-voiced consonants of kana in a related manner; wherein
said second display means includes means for detecting touch-up on said touch panel, and for displaying a list of options having names starting from any of kana in the item corresponding to the touched-up position, voiced consonants and semi-voiced consonants corresponding to said kana, among said plurality of options.

27. The user interface device according to claim 20, further comprising
means for highlighting, when one of said plurality of items is touched or touched and dragged, the corresponding item.

28. The user interface device according to claim 24, further comprising
means for highlighting said new window, in response to opening of said new window by said moving and display means.

29. The user interface device according to claim 20, wherein
said first display means includes representative character display means for displaying, on said touch-panel, a plurality of items each including a representative character representing a plurality of characters; and
said moving and display means includes
display enlarging means for enlarging, when one of the plurality of items including said starting characters is touched or touched and dragged, size of display of the item in said first direction,
means for displaying, when one of said plurality of items is touched or touched and dragged, the representative character that has been displayed in said item at a position different from original display position, and
display changing means for changing display on said touch panel such that all characters represented by the representative character of the item enlarged by said display enlarging means, and all items displayed by said first display means are displayed on said touch panel.

30. The user interface device according to claim 29, wherein
said display changing means includes means for displaying, in the item enlarged and displayed by said display enlarging means, all characters represented by said representative character of said item.

31. The user interface device according to claim 29, wherein
said display changing means includes means for displaying a new item at a position adjacent to the item enlarged and displayed by said display enlarging means, and displaying, in said new item, all characters represented by the representative character of the item enlarged and displayed by said display enlarging means.

32. The user interface device according to claim 29, wherein
said display changing means includes means for moving, in order to provide a new display area for item display between the item enlarged and displayed by said display enlarging means and an item succeeding said item, the display position of said succeeding item, and for displaying, in said new display area, a plurality of items respectively including characters represented by the representative character in said enlarged and displayed item.

33. The user interface device according to claim 29, wherein
said display changing means includes means for dividing each of the plurality of items succeeding the item enlarged and displayed by said display enlarging means to first and second areas, displaying in said first area representative characters that have been displayed in the plurality of items succeeding to said enlarged and displayed item, and in said second area, characters represented by the representative character that has been displayed in said enlarged and displayed item.

34. A computer program causing, when executed by a computer, said computer to operate as the user interface device according to claim 20.

35. A computer readable recording medium recording the computer program according to claim 34.

36. A user interface device, comprising:
means for displaying a plurality of items each including a character, on a touch panel having a display device;
means for displaying, when one of the plurality of items displayed on said touch panel is touched, the character of the item at a position different from original display position; and
means for displaying, when touched and then dragged, display of the character in the item corresponding to the dragged position at a position different from original display position.

37. The user interface device according to claim 36, further comprising
touch-up means for detecting a touch-tip after dragging on said touch panel;
wherein
the character in the item corresponding to the touch-up position, detected by said touch-up detecting means, is selected.

38. An information processing device including the user interface device according to claim 36.

39. An information processing device including the user interface device according to claim 37.
